(19) United States
(12) Patent Application Publication
(10) Pub. No.: US 2002/0024305 A1
(43) Pub. Date: Feb. 28, 2002

(54) Method for synchronizing a plurality of brushless motors in an elevating device

(75) Inventors: Kazuo Itoh, Kasai (JP); Toshiyuki Tachibana, Himeji (JP)

Correspondence Address: KODA & ANDROLIA, Suite 3850, 2029 Century Park East, Los Angeles, CA, 90067-3024, US

(73) Assignee: ITOH ELECTRIC CO., LTD.

(21) Appl. No.: 09/920,538

(22) Filed: Aug. 1, 2001

(30) Foreign Application Priority Data
Aug. 1, 2000 (JP) 2000-232802

(51) Int. Cl. H02P 1/54; H02P 5/46; H02P 7/68; H02P 7/74; H02P 7/80

(52) U.S. Cl. 318/34

(57) ABSTRACT

In an elevating device used in, for instance, a wheelchair, having a plurality of elevating assemblies at several positions and using compact brushless motors for driving the elevating assemblies. A run signal or a stop signal is sent to each of the brushless motors via a synchronous operation circuit. Whether a signal is a run signal or a stop signal is determined by comparing the pulse signals corresponding to rotations of the brushless motors with each other; and when the pulse signal of one brushless motor is larger than the pulse signal of another brushless motor, the brushless motor having the larger pulse signal stops.

### BACKGROUND OF THE DISCLOSURE

1. Field of the Invention

The present invention relates to a method for elevating an elevating device used in, for instance, a wheelchair and more particularly to a method for elevating an elevating device while maintaining the elevating device a certain position, for example, a horizontal position, when raising the elevating device using a plurality of blushless motors.

2. Prior Art

In an elevating device used in, for instance, a wheelchair, elevating means (motors, for instance) are provided at four corners of the elevating component of the elevating device for balancing. As a result, the elevating component is raised and lowered in a stable fashion. If the elevating component is supported at, for instance, only one point, then the elevating component cannot be stably raised and lowered.

Conventionally, elevating devices of this type employ timing belts or chains to transmit the power of one motor while mechanically synchronizing the elevating means that are provided at four corners.

In Japanese Patent Application Laid-Open (Kokai) No. 191299/2000, an elevating device is powered by four motors provided at four corners of the elevating component. These four motors are synchronized by a control device and drive the elevating component at four corners.

In another known conventional method, a timing belt or a timing chain is used to mechanically transmit the torque of one motor to a plurality of elevating means. However, this method requires a powerful motor. In addition, a complicated power transmission mechanism is required, and it needs a large space also. Thus, the elevating device tends to be quite large in size.

Japanese Patent Application Laid-Open (Kokai) No. 191299/2000 discloses an elevating device that is powered by four motors provided at four corners of the elevating component. These motors are synchronized by a control device so as to drive the elevating component at its four corners. However, no specific method for synchronizing the motors is disclosed in this prior art.

### SUMMARY OF THE INVENTION

In view of the above, the object of the present invention is to provide a method for easily and accurately synchronizing a plurality of motors, brushless motors, at a less cost.

The above object is accomplished by unique steps in a method for synchronizing several brushless motors in an elevating device, wherein a plurality of elevating means are provided at several positions of an elevating component, the elevating means are driven individually by brushless motors, the rotation (rpm) of the brushless motors for the elevating means are detected as pulse signals, and the pulse signal of any one of the brushless motors is compared with the pulse signal of at least another brushless motor; and when the pulse signal of one brushless motor is larger than the pulse signal of the compared brushless motor, the brushless motor having the larger pulse signal stops; and when the pulse signal of one brushless motor is smaller than the pulse signal of the compared brushless motor, the brushless motor having the smaller pulse signal rotates; thus rendering all the brushless motors of the elevating means to be synchronized.

To compare the pulse signals of the brushless motors, the pulse signals of two adjacent elevating means are compared so as to correlate the pulse signals of all brushless motors. When the pulse signal of one brushless motor is larger than any one of the compared pulse signals, the brushless motor having the larger pulse signal stops. In this way, a comparison chain of the pulse signals covers all the brushless motors, making it possible to synchronize all the brushless motors without failure. The stopping signal for a brushless motor can be used to decelerate the brushless motor.

As an elevating means, a motor roller incorporating a brushless motor is used with a rope or a belt wound around it. Thus, the whole structure of the elevating device can be simple.

### BRIEF DESCRIPTIONS OF THE DRAWINGS

FIG. 1 is a block diagram of the control mechanism of the synchronizing method for several brushless motors in the elevating device of the present invention;

FIG. 2 is a flow chart of the steps of the control method;

FIG. 3 illustrates an example of an elevating device that uses a motor roller as a driving means;

FIG. 4 illustrates an example of another elevating device that uses a motor roller as a driving means; and

FIG. 5 is a longitudinal sectional view of an example of a motor roller used as a reeling device for an elevating device.

### DETAILED DESCRIPTION OF THE INVENTION

Embodiments of the method for synchronizing several brushless motors in an elevating device according to the present invention will be described with reference to the accompanying drawings.

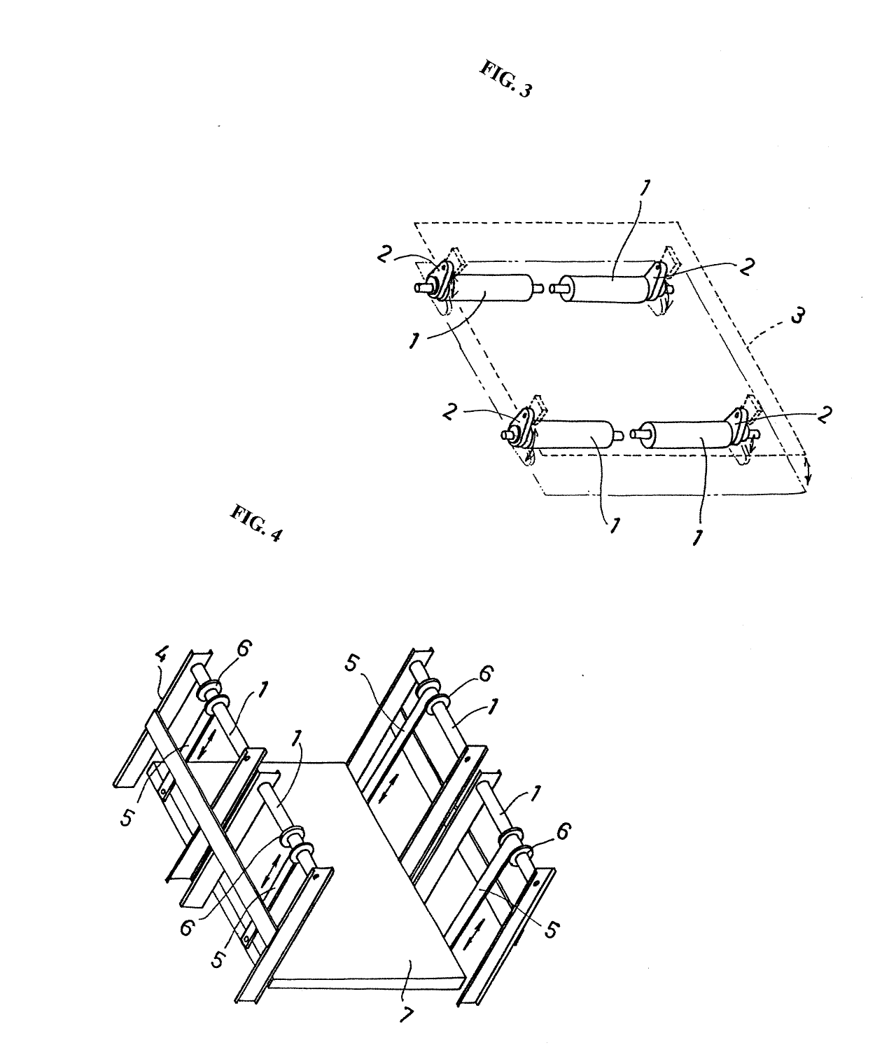

FIGS. 3 and 4 show embodiments that use motor rollers incorporating brushless motors as elevating means.

The elevating device shown in FIG. 3 comprises an elevating platform 3 and four motor rollers 1 each equipped with an eccentric cam (arm) 2. When the motor rollers 1 are turned 90° back and forth, the elevating platform 3 is raised and lowered between the position indicated by the dotted line and the position indicated by the two-dotted line.

The elevating device is placed at an appropriate position along the conveyor line and used as a sorting device that discharges a conveyed item sideways by raising the elevating platform 3. The elevating device of this embodiment raises and lowers the elevating platform 3 by rotating the motor roller 1 at a certain angle.

The elevating device shown in FIG. 4 comprises an elevating platform 7, a frame 4 and two motor rollers 1 each above the left and right sides of the frame 4. Each of four motor rollers 1 is provided with a reel 6, and a belt 5 is wound on the reel 6. The ends of the belts 5 are fastened to four corner areas of the platform 7. All four belts 5 are reeled in and out of the reel 6 at the same speed, thereby raising and lowering the elevating platform 7 while maintaining the horizontal position of the platform 7. The elevating device can be used in, for instance, a wheelchair.

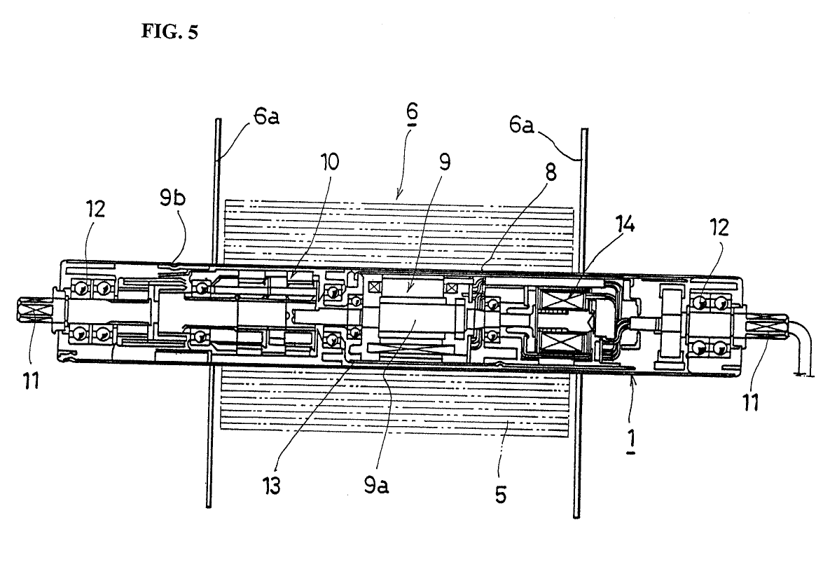

FIG. 5 shows a longitudinal section of a motor roller 1 that functions the reel 6.

More specifically, the motor roller 1 incorporates a brushless motor 9 inside its external tube 8, and the rotation of the rotor 9a of the brushless motor 9 is transmitted to the external tube 8 from an output part 9b via a reduction gear 10. The roller 1 is attached to the frame 4 via fixed shafts 11 provided at both ends of the roller 1. The external tube 8, which is linked to the rotor shaft 9a, rotates against the fixed shafts 11.

Between the external tube 8 and the fixed shafts 11, bearings 12 are provided for providing a smooth rotation. Inside the external tube 8, a fixed tube 13 is provided. The fixed tube 13 is provided with an electromagnetic brake 14 so as to be able to physically stop the rotation of the rotor shaft 9a.

Furthermore, the motor roller 1 has guide rings 6a fastened on the external tube 8 so that a part of the external tube 8 functions as the reel 6 for the belt 5.

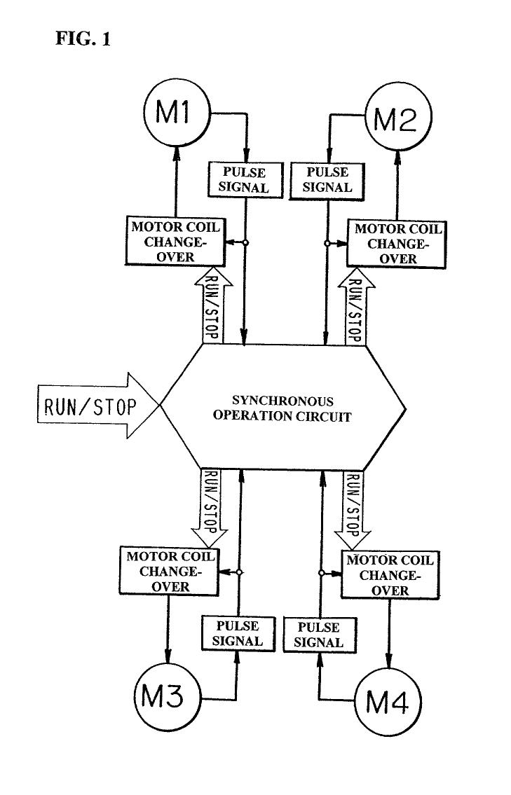

The operation of four brushless motors 9 (or motor rollers 1) will be described with reference to FIG. 1.

When a signal is inputted to the synchronous operation circuit, it is judged as a run signal or a stop signal by the synchronous operation circuit. Then, the signal, which is a run signal or a stop signal or a switch signal depending on the judgment of the synchronous operation circuit, is transmitted to motors M1 to M4, which are brushless motors 9. The rotation conditions of the brushless motors are fed back to the Synchronous operation circuit as pulse signals and compared with each other for all four brushless motors. Then, run signals are transmitted to the brushless motors so that the motors are synchronized.

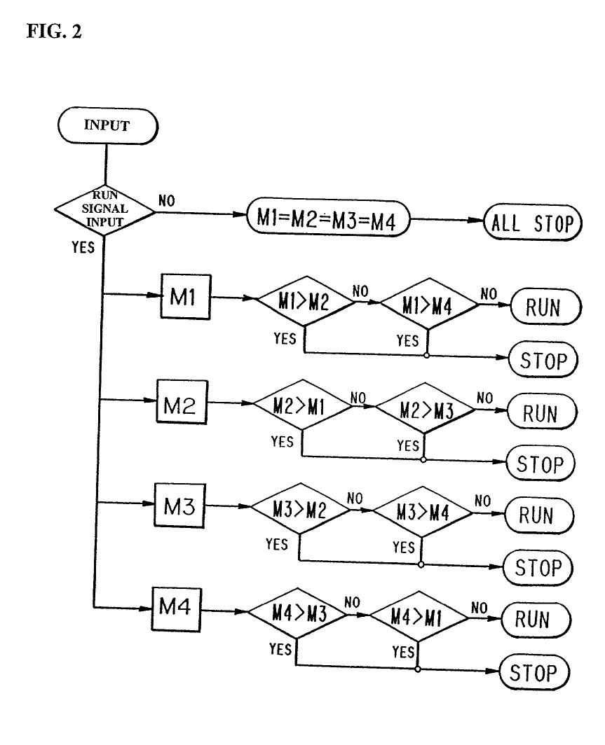

The control method for each one of the brushless motors will be described with reference to FIG. 2.

When there is no run signal from outside (in other words, when the external run signal is NO), the pulse signals for all of the brushless motors M1 to M4 are zero. In this case, stop signals are sent to all brushless motors, and the stopped condition is maintained.

When there is a run signal (in other words, when the run signal is YES), the number of pulses of motor M1 is compared with the number of pulses of motor M2, which is adjacent to the motor M1. If the number of pulses of motor M1 is larger, the motor M1 stops. If the number of pulses of motor M1 is smaller, then the number of pulses of motor M1 is compared with the number of pulses of motor M4, another adjacent motor. If the number of pulses of the motor M1 is larger, the motor M1 stops. The motor M1 runs (rotates) only when the number of pulses is smaller.

Next, the number of pulses of motor M2 is compared with the number of pulses of motor M1, which is adjacent to the motor M2. If the number of pulses of the motor M2 is larger than that of motor M1, the motor M2 stops. If the number of pulses of the motor M2 is smaller than that of motor M1, then the number of pulses of motor M2 is compared with that of the motor M3, another adjacent motor. If the number of pulses of the motor M2 is larger than that of the motor M3, the motor M2 stops. The motor M2 runs (rotates) only when the number of pulses is smaller than that of the motor M3.

In the same way, the motor M3 is compared with the motors M2 and M4 and stops or runs accordingly; and the motor M4 is compared with the motor M3 and M1 and stops or runs accordingly.

If the compared number of the pulses is the same, the pulses are treated as run (rotate) signals. If a run signal is inputted and a stop signal is sent to any of the brushless motors, the stop signal can be replaced with a deceleration signal. In this case, the movement of the elevating device becomes smoother.

As described above, the brushless motors M1 to M4 form a comparative link in which the number of pulses thereof is compared with each other among different pulse signals. More specifically, the pulse signals of all brushless motors are directly or indirectly compared with each other. In this way, all brushless motors 9 can synchronize accurately.

Depending on the type of elevating device, any number of brushless motors, i.e., elevating means, can be used. Even in a case that uses a larger number of brushless motors, the same structure as described above can be used to control the motors.

When using motor rollers incorporating brushless motors, the rotation (rpm) of each one of the motors can be detected as pulses at the motor driver that functions as the motor-roller driver.

In this way, a synchronous operation circuit is easily accomplished without a special device for detecting pulses.

In a motor roller 1 that incorporates a reduction gear, every time the external tube 8 of the motor roller 1 turns, the brushless motor 9 rotates several times, making it possible to detect several pulse signals. Because of this, as shown in FIG. 3, even in an elevating device in which the motor roller 1 rotates at a certain angle, the rotation (rpm) of the motor roller 1 can be accurately synchronized. When the motor roller 1 is used as a reel for reeling in a rope or reeling in a belt in an elevating device, an appropriate reduction ratio or diameter of the motor roller can be chosen with the range and speed of elevation of the elevating device taken into consideration so as to achieve the elevating device that best suits the object.

In conventional elevating device that uses several elevating means, the rotation of one motor is used to drive the several elevating means while mechanically synchronizing the elevating means using a chain or a timing belt. According to the method for synchronizing several brushless motors in an elevating device according to the present invention, several brushless motors can be driven synchronously so as to drive several elevating means. In this method, compact brushless motors can be used as power units without the need for mechanical synchronizing means between several elevating means. Thus, it is possible to provide a compact elevating device that merely requires a small space. The brushless motors, which are used as a power unit, can be synchronized without failure, assuring smooth driving of the elevating device.

Furthermore, according to the present invention, all brushless motors are synchronized without failure regardless of the number of elevating means.

In addition, a motor roller only needs to be mounted as an elevating means to reel in a rope or a belt. Therefore, there is no need to mount a motor and a reel separately, and the elevating device can be simple in structure.

What is claimed is:

1. A method for synchronizing a plurality of brushless motors in an elevating device, wherein:
a plurality of elevating means are provided at a plurality of positions of an elevating component,
said elevating means are individually driven by said brushless motors,
rotations (rpm) of said brushless motors for said elevating means are detected as pulse signals, and
a pulse signal of any one of said brushless motors is compared to a pulse signal of at least another brushless motor, and wherein
when a pulse signal of one brushless motor is larger than a pulse signal of a compared brushless motor, a brushless motor having a larger pulse signal stops, and
when a pulse signal of one brushless motor is smaller than a pulse signal of a compared brushless motor, a brushless motor having a smaller pulse signal rotates,
thus synchronizing all brushless motors of said elevating means.

2. The method for synchronizing several brushless motors according to claim 1, pulse signals of two adjacent elevating means are compared so as to correlate pulse signals of all brushless motors, wherein when a pulse signal of one brushless motor is larger than any one of compared pulse signals, said brushless motor having a larger pulse signal stops.

3. The method for synchronizing several brushless motors according to claim 1, wherein said elevating device is a motor roller that has a built-in brushless motor.

4. The method for synchronizing several brushless motors according to claim 2, wherein said elevating device is a motor roller that has a built-in brushless motor.
